(19) United States
(12) Patent Application Publication
(10) Pub. No.: US 2026/0046878 A1
(43) Pub. Date: Feb. 12, 2026

(54) COMMUNICATION METHOD, COMMUNICATION APPARATUS, COMPUTER-READABLE STORAGE MEDIUM, AND PROGRAM PRODUCT

(71) Applicant: HUAWEI TECHNOLOGIES CO., LTD., Shenzhen (CN)

(72) Inventors: Dongdong WEI, Shenzhen (CN); Fan WANG, Shanghai (CN); Liqing ZHANG, Ottawa (CA); Zhang ZHANG, Shanghai (CN); Qi FENG, Shanghai (CN)

(21) Appl. No.: 19/359,805

(22) Filed: Oct. 16, 2025

Related U.S. Application Data
(63) Continuation of application No. PCT/CN2023/088703, filed on Apr. 17, 2023.

(51) Int. Cl. H04W 72/21; H04W 68/02; H04W 72/044

(52) U.S. Cl. CPC H04W 72/21; H04W 68/02; H04W 72/044

(57) ABSTRACT

Disclosed embodiments provide a communication method and apparatus, a computer-readable storage medium, and a computer program product. In the method, when a camped cell of a terminal device changes from a first cell to a second cell and the terminal device satisfies a trigger condition for sending an uplink signal, the terminal device sends the uplink signal to a network device of the second cell, where the uplink signal indicates an identifier of the terminal device, and the trigger condition is associated with at least one of the following: a working status of the second cell, a moving speed of the terminal device, camping time of the terminal device in the first cell, or camping time of the terminal device in the second cell.

### CROSS-REFERENCE TO RELATED APPLICATIONS

This application is a continuation of International Application No. PCT/CN2023/088703, filed on Apr. 17, 2023, the disclosure of which is hereby incorporated by reference in its entirety.

### TECHNICAL FIELD

This disclosure relates to the communication field, and more specifically, to a communication method, a communication apparatus, a computer-readable storage medium, and a computer program product.

### BACKGROUND

In the 5G and 6G eras, AAUs (Active Antenna Units, active antenna units) are widely used, and a quantity of antennas on a base station side increases significantly. As a result, power consumption of a base station is multiplied in comparison with that in the 3G and 4G eras. In addition, a higher data rate and larger traffic need to be supported. Therefore, there are larger transmission bandwidths, and the power consumption of the base station side increases accordingly. The use of millimeter waves and terahertz leads to dense station deployment, and adding stations also means an increase in power consumption.

### SUMMARY

This application provides a communication method, a communication apparatus, a computer-readable storage medium, and a computer program product, to notify a network device when a camped cell of a terminal device changes, so that when subsequently sending paging for the terminal device, the network device can send the paging to the terminal device only via the camped cell of the terminal device, thereby reducing energy consumption of the network device.

According to a first aspect, a communication method is provided. The method may be performed by a terminal device, or may be performed by a chip used in the terminal device. The following is described by using an example in which the method is performed by a terminal device. In the method, when a camped cell of the terminal device changes from a first cell to a second cell and the terminal device satisfies a trigger condition for sending an uplink signal, the terminal device sends the uplink signal to a network device of the second cell, where the uplink signal indicates an identifier of the terminal device, and the trigger condition is associated with at least one of the following: a working status of the second cell, a moving speed of the terminal device, camping time of the terminal device in the first cell, or camping time of the terminal device in the second cell. In this way, the network device can be notified when the camped cell of the terminal device changes, so that the network device can subsequently send paging to the terminal device only via the camped cell, thereby reducing energy consumption of the network device.

In some implementations, the uplink signal notifies that the terminal device camps on the second cell. In this way, the network device of the camped cell can be notified of related information about the terminal device.

In some implementations, the uplink signal further indicates at least one of location information of the terminal device or beam information that the terminal device expects to receive a paging message. In this way, subsequently, paging can be sent to the terminal device only via the camped cell.

In some implementations, the trigger condition is associated with the working status of the second cell; and that the terminal device sends the uplink signal to the network device includes: The terminal device sends the uplink signal to the network device when the working status of the second cell is a low energy consumption state. In this way, an increase in energy consumption of a terminal side and a base station side is avoided.

In some implementations, the method further includes: receiving first configuration information from the network device, where the first configuration information includes at least one of the following information used to send the uplink signal: a time domain resource, a frequency domain resource, or a maximum quantity of sending times. In this way, the terminal device can send the uplink signal on the configured time domain resource or frequency domain resource, and the terminal device can send the uplink signal.

In some implementations, the trigger condition includes at least one of the following: the moving speed of the terminal device is less than a speed threshold; the camping time of the terminal device in the first cell is greater than a first time threshold; the camping time of the terminal device in the second cell is greater than a second time threshold; a paging cell list in a system message of the first cell includes the second cell; or a dedicated paging area of the terminal device does not include the second cell. It can be avoided that the terminal device frequently sends the uplink signal due to frequent changes of the camped cell of the terminal device, thereby reducing energy consumption of the terminal device.

In some implementations, the trigger condition is predefined, or is obtained by using configuration information of the network device. For example, in some implementations, one or more items in the foregoing trigger condition may be obtained from second configuration information of a network device of the first cell. In some other implementations, for example, the second time threshold in the foregoing trigger condition may be obtained from the network device of the second cell. In this way, the trigger condition can be flexibly set.

In some implementations, the uplink signal indicates the identifier of the terminal device by using at least one of the following: a radio resource control RRC message; a wake-up signal; an associated preamble sequence; or a predefined sequence. In this way, the network device identifies the terminal device.

In some implementations, the method further includes: The terminal device determines transmit power of the uplink signal based on received signal strength and transmit power of a low-power synchronization signal sent by the network device of the second cell, and a quantity of repetition times of the low-power synchronization signal, where the quantity of repetition times of the low-power synchronization signal is a quantity of times that the network device of the second cell repeatedly sends the low-power synchronization signal or a quantity of times that the terminal device repeatedly receives the low-power synchronization signal. In this way, a path loss can be estimated more accurately and the transmit power can be determined.

In some implementations, the method further includes: The terminal device receives an acknowledgment indication of the uplink signal from the network device of the second cell. In this way, the terminal device can learn, based on the acknowledgment indication, whether the network device successfully receives the uplink signal.

In some implementations, the acknowledgment indication is listened to in at least one of the following: a slot at a predetermined quantity of slots after a slot in which the uplink signal is sent; or a predefined detection window after a slot in which the uplink signal is sent. In this way, the terminal device can correctly detect the acknowledgment indication of the uplink signal.

In some implementations, the acknowledgment indication is carried in at least one of the following: a medium access control control element; downlink control information; or a radio resource control RRC message. In this way, impact of overheads such as a delay is reduced.

In some implementations, the method further includes: when a quantity of times of sending the uplink signal is less than the maximum quantity of sending times of sending the uplink signal, resending the uplink signal to the network device of the second cell when the terminal device does not receive the acknowledgment indication of the uplink signal from the network device of the second cell. In this way, a success rate of receiving the uplink signal by the network device is improved.

In some implementations, the method further includes: The terminal device receives a paging message from the network device of the second cell. In this way, only the network device of the second cell sends the paging message, thereby reducing power consumption of the network device.

In some implementations, the terminal device is in an idle state or an inactive state. The solutions in embodiments of this disclosure are applicable to cell reselection of a terminal device in a non-connected state.

According to a second aspect, a communication method is provided. For beneficial effects, refer to the descriptions of the first aspect. Details are not described herein again. The method may be performed by a network device of a second cell, or may be performed by a chip in the network device of the second cell. The following is described by using an example in which the method is performed by a network device of a second cell. In the method, the network device of the second cell sends first configuration information used by a terminal device to send an uplink signal, where the first configuration information includes at least one of the following information used to send the uplink signal: a time domain resource, a frequency domain resource, or a maximum quantity of sending times; and the network device receives the uplink signal from the terminal device, where the uplink signal notifies that the terminal device camps on the second cell.

In some implementations, the uplink signal indicates an identifier of the terminal device.

In some implementations, the uplink signal indicates the identifier of the terminal device by using at least one of the following: a radio resource control RRC message; a wake-up signal; an associated preamble sequence; or a predefined sequence.

In some implementations, the uplink signal further indicates at least one of location information of the terminal device or beam information that the terminal device expects to receive a paging message.

In some implementations, a receiving condition of an uplink signal is associated with a working status of the second cell; and that the network device receives the uplink signal includes: The network device receives the uplink signal when the working status of the second cell is a low energy consumption state.

In some implementations, the receiving condition of the uplink signal includes at least one of the following: a moving speed of the terminal device is less than a speed threshold; camping time of the terminal device in the second cell is greater than a second time threshold; a paging cell list in a system message of a first cell includes the second cell; or a dedicated paging area of the terminal device does not include the second cell.

In some implementations, the network device may further send the second time threshold to the terminal device.

In some implementations, the method further includes: The network device sends an acknowledgment indication of the uplink signal to the terminal device.

In some implementations, the network device sends the acknowledgment indication in at least one of the following: a slot at a predetermined quantity of slots after a slot in which the uplink signal is received; or a predefined detection window after a slot in which the uplink signal is received.

In some implementations, the acknowledgment indication is carried in at least one of the following: a medium access control control element; downlink control information; or a radio resource control RRC message.

In some implementations, the method further includes: The network device sends a paging message to the terminal device after receiving the uplink signal.

In some implementations, the method further includes: The network device updates or stores, after receiving the uplink signal, a camped cell of the terminal device as the second cell.

In some implementations, the network device is a first network device, and the method further includes: The first network device sends notification information to a second network device of the first cell, where the notification information indicates that the camped cell of the terminal device changes from the first cell to the second cell.

According to a third aspect, a communication method is provided. The method may be performed by a second network device of a first cell, or may be performed by a chip used in the second network device. The following is described by using an example in which the method is performed by a second network device. In the method, the second network device sends, to a terminal device, second configuration information used by the terminal device to obtain a trigger condition for sending an uplink signal, where the trigger condition is associated with at least one of the following: a working status of a second cell, a moving speed of the terminal device, camping time of the terminal device in the first cell, or camping time of the terminal device in the second cell, and the uplink signal indicates an identifier of the terminal device; and the second network device receives notification information from a first network device, where the notification information indicates that a camped cell of the terminal device changes from the first cell to the second cell.

In some implementations, the uplink signal notifies that the terminal device camps on the second cell.

In some implementations, the uplink signal further indicates at least one of location information of the terminal device or beam information that the terminal device expects to receive a paging message.

In some implementations, the trigger condition includes at least one of the following: the moving speed of the terminal device is less than a speed threshold; the camping time of the terminal device in the first cell is greater than a first time threshold; the camping time of the terminal device in the second cell is greater than a second time threshold; a paging cell list in a system message of the first cell includes the second cell; or a dedicated paging area of the terminal device does not include the second cell.

In some implementations, the uplink signal indicates the identifier of the terminal device by using at least one of the following: a radio resource control RRC message; a wake-up signal; an associated preamble sequence; or a predefined sequence.

In some implementations, the method further includes: The second network device receives the notification information from the first network device, where the notification information indicates that the camped cell of the terminal device changes from the first cell to the second cell; and the second network device deletes information about the terminal device or sends information about the terminal device to the first network device based on the notification information.

According to a fourth aspect, a communication apparatus is provided. For beneficial effects, refer to the descriptions of the first aspect. Details are not described herein again. The communication apparatus has functions of implementing behavior in the method instance in the first aspect. The functions may be implemented by hardware, or may be implemented by executing corresponding software by hardware. The hardware or software includes one or more modules corresponding to the foregoing functions. In a possible design, the communication apparatus includes: a sending unit, configured to: when a camped cell of a terminal device changes from a first cell to a second cell and the terminal device satisfies a trigger condition for sending an uplink signal, send the uplink signal to a network device of the second cell, where the uplink signal indicates an identifier of the terminal device, and the trigger condition is associated with at least one of the following: a working status of the second cell, a moving speed of the terminal device, camping time of the terminal device in the first cell, or camping time of the terminal device in the second cell.

According to a fifth aspect, a communication apparatus is provided. For beneficial effects, refer to the descriptions of the first aspect. Details are not described herein again. The apparatus has functions of implementing behavior in the method instance in the second aspect. The functions may be implemented by hardware, or may be implemented by executing corresponding software by hardware. The hardware or software includes one or more modules corresponding to the foregoing functions. In a possible design, the communication apparatus includes: a sending unit, configured to send first configuration information used by a terminal device to send an uplink signal, where the first configuration information includes at least one of the following information used to send the uplink signal: a time domain resource, a frequency domain resource, or a maximum quantity of sending times; and a receiving unit, configured to receive the uplink signal from the terminal device, where the uplink signal notifies that the terminal device camps on a second cell.

According to a sixth aspect, a communication apparatus is provided. For beneficial effects, refer to the descriptions of the first aspect. Details are not described herein again. The apparatus has functions of implementing behavior in the method instance in the second aspect. The functions may be implemented by hardware, or may be implemented by executing corresponding software by hardware. The hardware or software includes one or more modules corresponding to the foregoing functions. In a possible design, the communication apparatus includes: a sending unit, configured to send, to a terminal device, second configuration information used by the terminal device to obtain a trigger condition for sending an uplink signal, where the trigger condition is associated with at least one of the following: a working status of a second cell, a moving speed of the terminal device, camping time of the terminal device in a first cell, or camping time of the terminal device in the second cell, and the uplink signal indicates an identifier of the terminal device; and a receiving unit, configured to receive notification information from a first network device, where the notification information indicates that a camped cell of the terminal device changes from the first cell to the second cell.

According to a seventh aspect, a communication apparatus is provided, including a processor and a memory storing instructions. When the instructions are executed by the processor, any method according to the first aspect and the implementations of the first aspect is performed.

According to an eighth aspect, a communication apparatus is provided, including a processor and a memory storing instructions. When the instructions are executed by the processor, any method according to the second aspect and the implementations of the second aspect is performed.

According to a ninth aspect, a communication apparatus is provided, including a processor and a memory storing instructions. When the instructions are executed by the processor, any method according to the third aspect and the implementations of the third aspect is performed.

According to a tenth aspect, a computer-readable storage medium is provided. The computer-readable storage medium stores instructions, and when the instructions are executed, the method performed by the communication apparatus according to the fourth aspect, the fifth aspect, or the sixth aspect in the foregoing aspects is performed.

According to an eleventh aspect, a computer program product is provided. The computer program product includes instructions, and when the instructions are executed by an electronic device, the method performed by the communication apparatus according to the fourth aspect, the fifth aspect, or the sixth aspect in the foregoing aspects is performed.

According to a twelfth aspect, this application provides a chip system. The chip system includes a processor, configured to implement the functions of the communication apparatus in the fourth aspect, the fifth aspect, or the sixth aspect of the methods in the foregoing aspects. In a possible design, the chip system further includes a memory, configured to store program instructions and/or data. The chip system may include a chip, or may include a chip and another discrete component.

According to a thirteenth aspect, this application further provides a communication system, including: a communication apparatus configured to perform the method according to the first aspect, or a communication apparatus configured to perform the method according to the second aspect and a communication apparatus configured to perform the method according to the third aspect.

### BRIEF DESCRIPTION OF DRAWINGS

FIG. 1A is a diagram of a communication system according to some embodiments of this disclosure;

FIG. 1B is a diagram of a communication system according to some other embodiments of this disclosure;

FIG. 2 is a schematic flowchart of a communication method according to some embodiments of this disclosure;

FIG. 3 is a diagram of base stations of different area types according to some embodiments of this disclosure;

FIG. 4 is a schematic flowchart implemented at a first communication apparatus according to some embodiments of this disclosure;

FIG. 5 is a schematic flowchart implemented at a second communication apparatus according to some embodiments of this disclosure;

FIG. 6 is a schematic flowchart implemented at a third communication apparatus according to some embodiments of this disclosure;

FIG. 7 is a diagram of main composition of an example device in a possible implementation according to an embodiment of this disclosure; and

FIG. 8 is a simplified block diagram of an example device in a possible implementation according to an embodiment of this disclosure.

### DESCRIPTION OF EMBODIMENTS

Embodiments of this disclosure are described in more detail in the following with reference to the accompanying drawings. Although some embodiments of this disclosure are shown in the accompanying drawings, it should be understood that this disclosure can be implemented in various forms, and should not be construed as being limited to embodiments described herein, and instead, these embodiments are provided for a more thorough and complete understanding of this disclosure. It should be understood that the accompanying drawings and embodiments of this disclosure are merely used as examples and are not intended to limit the protection scope of this disclosure.

In the descriptions of embodiments of this disclosure, the term “including” and similar terms thereof shall be understood as open inclusion, that is, “including but not limited to”. The term “based on” should be understood as “at least partially based on”. The term “one embodiment” or “this embodiment” should be understood as “at least one embodiment”. The terms “first”, “second”, and the like may indicate different objects or a same object. Other explicit and implicit definitions may also be included below.

Embodiments of this disclosure may be implemented according to any proper communication protocol, including but not limited to cellular communication protocols such as fourth generation (4G), fifth generation (5G), and future communication protocols (for example, sixth generation (6G)).

Technical solutions in embodiments of this disclosure are applied to a communication system that complies with any proper communication protocol, for example, a general packet radio service (General Packet Radio Service, GPRS), a global system for mobile communications (Global System for Mobile Communications, GSM), an enhanced data rate for GSM evolution (Enhanced Data rate for GSM Evolution, EDGE) system, a universal mobile telecommunications system (Universal Mobile Telecommunications System, UMTS), a long term evolution (Long Term Evolution, LTE) system, a wideband code division multiple access (Wideband Code Division Multiple Access, WCDMA) system, a code division multiple access 2000 (Code Division Multiple Access, CDMA2000) system, a time division-synchronization code division multiple access (Time Division-Synchronization Code Division Multiple Access, TD-SCDMA) system, a frequency division duplex (Frequency Division Duplex, FDD) system, a time division duplex (Time Division Duplex, TDD) system, a 5th generation (5G) system (for example, new radio (New Radio, NR)), a future communication system (for example, a 6th generation (6G) system), and the like.

For the purpose of illustration, the following describes embodiments of this disclosure in a background of a 5G communication system in 3GPP (3rd Generation Partnership Project, 3rd Generation Partnership Project). However, it should be understood that embodiments of this disclosure are not limited to the communication system, but may be applied to any communication system having a similar problem, for example, a wireless local area network (WLAN), a wired communication system, or another communication system developed in the future.

The term “terminal” or “terminal device” used in this disclosure refers to any terminal device that can perform wired or wireless communication with a network device or any terminal devices that can perform wired or wireless communication with each other. The terminal device may be sometimes referred to as user equipment (User Equipment, UE). The terminal device may be any type of mobile terminal, fixed terminal, or portable terminal. The terminal device may be various wireless communication devices that have a wireless communication function. With emergence of an Internet of Things (Internet of Things, IOT) technology, increasingly more devices that previously have no communication function, for example, but not limited to, a household appliance, a transportation tool, a tool device, a service device, and a service facility, start to obtain a wireless communication function by being configured with a wireless communication unit, so as to access a wireless communication network and accept remote control. Such a device has the wireless communication function because the device is configured with the wireless communication unit, and therefore also belongs to a scope of a wireless communication device. For example, the terminal device may include a mobile cellular phone, a cordless phone, a mobile terminal (Mobile Terminal, MT), a mobile station, a mobile device, a wireless terminal, a handheld device, a client, a subscription station, a portable subscription station, an Internet node, a communicator, a desktop computer, a laptop computer, a notebook computer, a tablet computer, a personal communication system device, a personal navigation device, a personal digital assistant (Personal Digital Assistant, PDA), a wireless data card, a wireless modulator demodulator (Modulator demodulator, Modem), a positioning device, a radio broadcast receiver, an e-book device, a game device, an Internet of Things (Internet of Things, IoT) device, a vehicle-mounted device, an aircraft, a virtual reality (Virtual Reality, VR) device, an augmented reality (Augmented Reality, AR) device, a wearable device (for example, a smart watch), a terminal device in a 5G network or any terminal device in an evolved public land mobile network (Public Land Mobile Network, PLMN), another device that can be used for communication, or any combination thereof. This is not limited in embodiments of this disclosure.

The term “network node” or “network device” used in this disclosure is an entity or a node that may be configured to communicate with a terminal device, for example, may be an access network device. The access network device may be an apparatus that is deployed in a radio access network and that provides a wireless communication function for a mobile terminal. For example, the access network device may be a radio access network (Radio Access Network, RAN) network device. The access network device may include various types of base stations. The base station is configured to provide a radio access service for the terminal device. Specifically, each base station corresponds to a service coverage area, and a terminal device entering the area may communicate with the base station by using a radio signal, to receive the radio access service provided by the base station. The service coverage areas of base stations may overlap, and a terminal device in an overlapping area may receive radio signals from a plurality of base stations. Therefore, the plurality of base stations may simultaneously provide services for the terminal device. Based on a size of the provided service coverage area, the access network device may include a macro base station providing a macro cell (Macro cell), a micro base station providing a micro cell (Micro cell), a pico base station providing a pico cell, and a femto base station providing a femto cell (Femto cell). In addition, the access network device may further include various forms of relay stations, access points, remote radio units (Remote Radio Unit, RRU), radio heads (Radio Head, RH), remote radio heads (Remote Radio Head, RRH), and the like. In systems using different radio access technologies, the access network device may have different names. For example, the access network device is referred to as an evolved NodeB (evolved NodeB, eNB or eNodeB) in a long term evolution (Long Term Evolution, LTE) system network, is referred to as a NodeB (NodeB, NB) in a 3G network, may be referred to as a gNodeB (gNB) or an NR NodeB (NR NB) in a 5G network, or the like. In some scenarios, the access network device may include a central unit (Central Unit, CU) and/or a distributed unit (Distributed Unit, DU). The CU and the DU may be deployed in different places. For example, the DU is remotely deployed in a high-traffic area, and the CU is deployed in a central equipment room. Alternatively, the CU and the DU may be deployed in a same equipment room. The CU and the DU may alternatively be different components in a rack. For ease of description, in subsequent embodiments of this disclosure, the foregoing apparatuses that provide a wireless communication function for the mobile terminal are collectively referred to as a network device. The apparatus may alternatively be a chip or a module that is in the mobile terminal or the access network device and that implements a related wireless communication function. This is not specifically limited in embodiments of this disclosure.

For a terminal in a non-connected state, when there is a paging message, because the network device cannot obtain a camped cell of the terminal, a plurality of network devices deliver paging messages. However, this causes high energy consumption and unnecessary sending on a network side. Therefore, the NR system supports a tracking area (Tracking Area, TA) and a RAN-based notification area (RAN-based Notification Area). When UE register with a network, a core network assigns a UE registration area (UE Registration Area) to the UE. The UE registration area includes a TAI (Tracking Area Identifier, tracking area identifier) list. When the UE moves out to a cell that does not belong to the TAI list, the UE actively accesses the network (including the core network), and performs NAS (non-access stratum, non-access stratum) registration update. The core network registers a location of the UE and updates the registration area of the UE, that is, reassigns, to the UE, a TAI list including a TA to which the cell in which the UE is currently located belongs. When the UE is in an RRC (radio resource control, radio resource control) idle state, to find the UE, the network needs to deliver a paging message to all cells in all TAs in the TAI list, which is referred to as core network-level terminal tracking. It is clear that, in this level of terminal tracking, because most paging messages are delivered in a cell in which the UE is not located, high paging message transmission overheads are generated. To reduce the transmission overheads, a paging message delivery range needs to be narrowed. For UE in the RRC idle state, a minimum granularity area managed by the network side is the TA of the core network.

For UE in an RRC inactive state, the concept of an RNA (RAN-based Notification Area), which has a smaller range than the TA, is introduced to further reduce the paging message transmission overheads. The RNA is managed by a gNodeB, and the gNodeB can page UE based on the RNA (RAN paging) to find the UE, which is referred to as radio access network-level terminal tracking. In this mechanism, for inactive UE, because the terminal moves, a camped cell of the UE may change. When the UE moves to a new RNA area, the UE re-accesses a network and registers with the new RNA area. When the UE has paging requirement, all base stations in an RNA area in which a previous camped cell of the UE is located need to send paging messages.

It can be learned that, the foregoing paging mechanism does not consider energy saving of the base station and assumes that the base station is always online, and therefore paging to the UE is initiated in the TA/RNA area. However, this increases unnecessary sending and energy consumption of the base station, and reduces sleep time of the base station. In some solutions, the TA area and the RNA area are changed to one cell. However, after the TA area is updated, the UE initiates NAS registration update. If the TA area is set to an excessively small value, access overheads and RRC signaling overheads are increased. Similarly, after the terminal moves to a new RNA area, RNA update is triggered. That is, an RRC resume request is initiated, and resumeCause is set to rna-Update, which increases access resource overheads and RRC signaling overheads.

The design of the foregoing paging mechanism does not consider a working status of a base station side, and does not maximize an energy saving gain of the base station. As a result, when the terminal has a paging requirement, a plurality of base stations send paging requests. In this case, for a base station with no load or light load, unnecessary paging sending accounts for a high proportion of total energy consumption of the base station. That is, for the base station with no load or light load, unnecessary paging sending causes unnecessary power consumption on the base station side. In embodiments of this disclosure, the foregoing scenario is optimized, to reduce the energy consumption on the base station side.

To make the objectives, technical solutions, and advantages of this application clearer, the following further describes this application in detail with reference to the accompanying drawings. Specific operation methods, function descriptions, and the like in method embodiments may also be applied to apparatus embodiments or system embodiments.

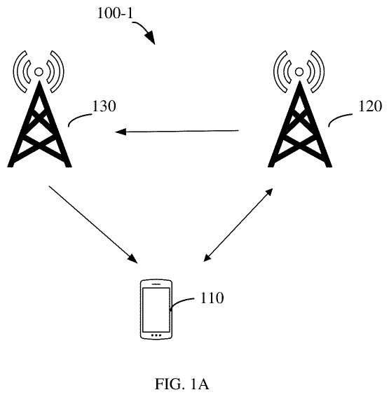

FIG. 1A is a diagram of a communication system according to some embodiments of this disclosure. The communication system 100-1 may include a terminal device 110 and network devices 120 and 130. In some embodiments, the network device 120 may be referred to as a first network device 120. In some embodiments, the network device 130 may be referred to as a second network device 130. The terminal device 110 may separately communicate with the first network device 120 and the second network device 130. For example, in some embodiments, the terminal device 110 may separately receive configuration information from the first network device 120 and the second network device 130. In some embodiments, the terminal device 110 may further send an uplink signal to the first network device 120 under a specific trigger condition. In some embodiments, the terminal device 110 may be UE or the like. In some embodiments, the network devices 120 and 130 may be base stations or the like.

FIG. 1B is a diagram of a communication system according to some other embodiments of this disclosure. The communication system 100-2 in this embodiment of this disclosure may be used in a future 5G network, a future 6G network, and the like, but is not limited to the networks listed above. The communication system 100-2 may include a terminal device 110, a network device 140, and a network device 150. It should be noted that, the terminal device 110 may be connected to the network device 140, and the network device 140 may be connected to the network device 150. In some embodiments, the network device 140 and the network device 150 may be based on a same standard, for example, 5G or 6G. In some embodiments, the terminal device 110 may be UE. In some embodiments, the network device 140 may be a base station, for example, a specific example of the network devices 120 and 130. In some embodiments, the network device 150 may alternatively be a core network device. In some embodiments, for example, in an SA (standalone access, standalone access) scenario, the UE is connected to a single base station, and the base station connected to the UE and a core network device connected to the base station are of a same standard. For example, the core network is a 5G Core, the base station is a 5G base station correspondingly, and the 5G base station is directly connected to the 5G Core; or the core network is a 6G Core, the base station is a 6G base station, and the 6G base station is directly connected to the 6G Core.

Embodiments of this disclosure may be used in 5.5G, 6G, and later wireless communication systems, and are applicable to scenarios including but not limited to terrestrial cellular communication, NTN (non-terrestrial network, non-terrestrial communication network, or non-terrestrial communication network), satellite communication, HAPS (high altitude platform station, high altitude communication platform) communication, V2X (vehicle-to-everything, vehicle-to-everything), IAB (integrated access and backhaul, integrated access and backhaul), RIS (reconfigurable intelligent surface, reconfigurable intelligent surface) communication, and the like.

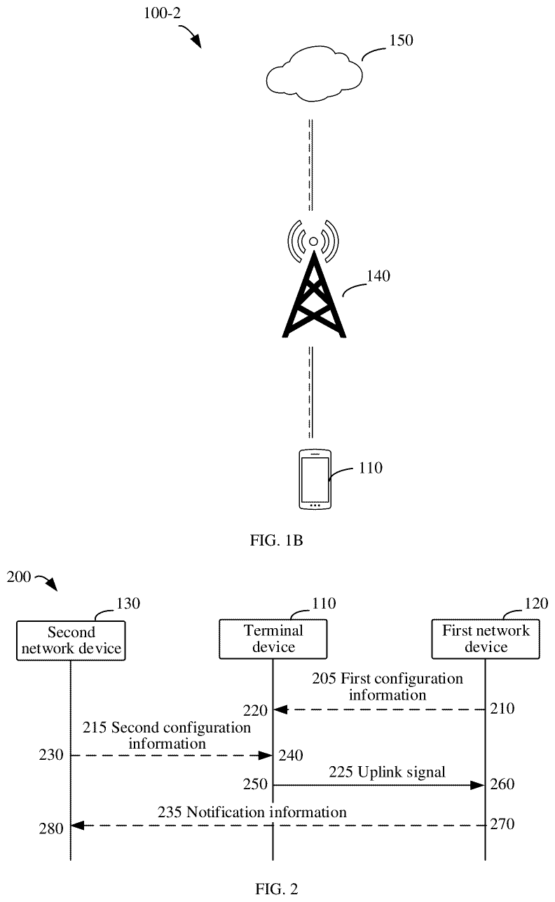

FIG. 2 is a schematic flowchart of a communication method according to some embodiments of this disclosure. As shown in FIG. 2, in a procedure 200, a network device 120 (which may be referred to as a first network device 120) of a second cell sends (210) first configuration information 205 used by a terminal device 110 to send an uplink signal 225. The first configuration information 205 includes one or more of the following information used by the terminal device 110 to send the uplink signal 225: a time domain resource, a frequency domain resource, or a maximum quantity of sending times. On a terminal device 110 side, the terminal device 110 may receive (220) the first configuration information 205. A second network device 130 sends (230), to the terminal device 110, second configuration information 215 used by the terminal device 110 to obtain a trigger condition for sending the uplink signal. Correspondingly, on the terminal device 110 side, the terminal device 110 may receive (240) the second configuration information 215. In this embodiment, one or more items in the trigger condition are obtained from the second network device 130. In some other embodiments not shown in FIG. 2, for example, an item in the trigger condition may be obtained from the first network device 120. For example, the trigger condition may include that camping time of the terminal device 110 in the second cell is greater than a second time threshold, and the second time threshold may be obtained from the first network device 120. In other words, for an example in which the trigger condition includes the second time threshold, the second time threshold may be obtained from the first network device 120, or alternatively, may be obtained from the second network device 130. The trigger condition is associated with one or more of a working status of the second cell, a moving speed of the terminal device, camping time of the terminal device 110 in a first cell, or the camping time of the terminal device 110 in the second cell, and the uplink signal indicates an identifier of the terminal device 110. When a camped cell of the terminal device 110 changes from the first cell to the second cell and the terminal device 110 satisfies the trigger condition for sending the uplink signal, the terminal device 110 sends (250) the uplink signal 225 to the network device of the second cell. In some embodiments, the uplink signal 225 may indicate the identifier of the terminal device 110. The network device 120 of the second cell receives (260) the uplink signal 225 from the terminal device 110, where the uplink signal 225 notifies that the terminal device 110 camps on the second cell. In some embodiments, the first network device 120 may further send (270) notification information 235 to the second network device 130. In some embodiments, the second network device 130 may receive (280) the notification information 235 from the first network device 120, for example, receive the notification information from the first network device 120, where the notification information 235 indicates that the camped cell of the terminal device 110 changes from the first cell to the second cell.

In some embodiments, the terminal device 110 may be in an idle state or an inactive state.

According to some embodiments of this disclosure, after completing cell reselection, the terminal device 110 in a non-connected state (the idle state or the inactive state) determines, based on the trigger condition, whether to send the uplink signal.

In some embodiments, the terminal device 110 sends the uplink signal 225, so that a base station obtains information about the camped cell of the terminal device 110 in the idle state. When there is a paging request of the terminal device 110, a paging message only needs to be sent in the current camped cell, thereby avoiding unnecessary energy consumption overheads on a base station side caused by simultaneous sending of paging messages in a plurality of cells.

In some embodiments, the uplink signal 225 may notify that the terminal device 110 camps on the second cell.

In some embodiments, the uplink signal 225 may indicate location information of the terminal device 110, or indicate beam information that the terminal device 110 expects to receive a paging message, or indicate the foregoing two pieces of information. In some other embodiments, the uplink signal 225 may indicate beam information that the terminal device 110 is to receive a paging message.

In some embodiments, the trigger condition may be associated with the working status of the second cell. The terminal device 110 sends the uplink signal 225 to the network device 120 of the second cell. Specifically, when the working status of the second cell is a low energy consumption state, the terminal device 110 may send the uplink signal 225 to the network device 120. Correspondingly, on a side of the network device 120 of the second cell, the network device 120 receives the uplink signal 225. Specifically, when the working status of the second cell is the low energy consumption state, the network device 120 of the second cell receives the uplink signal 225. In some embodiments, whether the terminal device 110 side sends the uplink signal 225 is determined based on the working status of the second cell or an energy consumption status of the network device. When the network device 120 of the second cell is in a high power consumption working state, the terminal device 110 reuses an existing procedure, that is, when camping on the second cell, the terminal device 110 does not need to send the uplink signal 225, thereby avoiding an increase in the energy consumption on the terminal side.

In some embodiments, the network device 120 may have a plurality of working statuses, and different working statuses may have different energy consumption. For example, in some embodiments, the network device 120 may have two working statuses: a high energy consumption mode and a low energy consumption mode. For a cell in the high energy consumption mode, the network device 120 of the cell has long working time. On the contrary, for a cell in the low energy consumption mode, the network device 120 of the cell has short working time and has longer sleep time. For the cell in the high energy consumption mode, a working status of the cell may be referred to as a high energy consumption state. Correspondingly, for the cell in the low energy consumption mode, a working status of the cell may be referred to as a low energy consumption state. In some embodiments, a working status of a cell, for example, the low energy consumption state or the high energy consumption state, may be obtained by receiving a downlink signal or by using a higher layer signaling indication.

In some embodiments, the trigger condition for sending the uplink signal is associated with one or more of the working status of the second cell, the moving speed of the terminal device 110, the camping time of the terminal device 110 in the first cell, or the camping time of the terminal device 110 in the second cell. Specifically, the trigger condition may include: the moving speed of the terminal device is less than a speed threshold, the camping time of the terminal device 110 in the first cell is greater than a first time threshold, the camping time of the terminal device 110 in the second cell is greater than the second time threshold, a paging cell list in a system message of the first cell includes the second cell, a dedicated paging area of the terminal device 110 does not include the second cell, or a combination of one or more items in the foregoing trigger condition. For example, in some embodiments, when the moving speed of the terminal device 110 is less than the speed threshold and the working status of the second cell is the low energy consumption state, if the camped cell of the terminal device 110 changes, sending of the uplink signal 225 is triggered. For example, in some other embodiments, when the camping time of the terminal device 110 in the first cell is greater than the first time threshold and the working status of the second cell is the low energy consumption state, if the camped cell of the terminal device 110 changes, sending of the uplink signal 225 is triggered. For example, in still some other embodiments, when the paging cell list in the system message of the first cell includes the second cell, if the camped cell of the terminal device 110 changes, sending of the uplink signal 225 is triggered. For example, in still some other embodiments, when the dedicated paging area of the terminal device 110 does not include the second cell, if the camped cell of the terminal device 110 changes, sending of the uplink signal 225 is triggered. Examples of the combination of one or more items in the foregoing trigger condition are not listed one by one.

In some embodiments, the trigger condition may be predefined. In some other embodiments, the trigger condition may be obtained from second configuration information of a network device 120 of the first cell. In some embodiments, some thresholds may be configured in the second configuration information, for example, one or more of the speed threshold, the first time threshold, the second time threshold, an energy consumption mode (for example, the high energy consumption mode or the low energy consumption mode), or the like. In still some other embodiments, the second time threshold may be obtained from the network device 120 of the second cell, that is, the network device 120 of the second cell configures the second time threshold for the terminal device 110.

In some embodiments, on the side of the network device 120 of the second cell, a receiving condition of the uplink signal 225 may include: the moving speed of the terminal device 110 is less than the speed threshold, the camping time of the terminal device 110 in the second cell is greater than the second time threshold, the paging cell list in the system message of the first cell includes the second cell, the dedicated paging area of the terminal device 110 does not include the second cell, or the receiving condition may include two or more of the conditions mentioned above.

In some embodiments, the uplink signal may indicate the identifier of the terminal device 110 in one or more manners, for example, by using a radio resource control (RRC) message, by using a wake-up signal, by using an associated preamble sequence, by using a predefined sequence, or by using a combination of two or more of the foregoing indication manners. The wake-up signal is, for example, an LP-WUS (Low-Power Wake-up Signal, low-power wake-up signal). For a case that the identifier of the terminal device 110 is indicated by using an RRC message, for example, a defined uplink RRC message may be used, and the uplink RRC message carries TMSI information configured by a higher layer or a UE identifier (an example of the identifier of the terminal device 110) indicated in an LP-WUS (Low-Power Wake-up Signal, low-power wake-up signal).

In some embodiments, the terminal device 110 may determine transmit power of the uplink signal 225 based on received signal strength and transmit power of a low-power synchronization signal sent by the network device 120 of the second cell, and a quantity of repetition times of the low-power synchronization signal, where the quantity of repetition times of the low-power synchronization signal is a quantity of times that the network device 120 of the second cell repeatedly sends the low-power synchronization signal or a quantity of times that the terminal device 110 repeatedly receives the low-power synchronization signal.

In some embodiments, the transmit power of the uplink signal 225 may be calculated in the following manner. Specific power control calculation is shown in the following formula:

P_{UL_Signal}=min{Pmax, P_{UL_Signal_target}+PL}, where Pmax is maximum transmit power of the terminal device 110, P_{UL_Signal_target} is target power of the uplink signal configured by a higher layer, and PL is a path loss. The path loss may be calculated based on transmit power Tx_Power, signal received power Rx_Power, and a quantity n of repetition times, for example, PL=Tx_Power−Rx_Power+3*log2(n).

In some embodiments, the network device 120 of the second cell may send an acknowledgment indication of the uplink signal 225 to the terminal device 110. Correspondingly, in some embodiments, the terminal device 110 may receive the acknowledgment indication of the uplink signal 225 from the network device 120 of the second cell. In some embodiments, the network device 120 may send the acknowledgment indication in a slot at a predetermined quantity of slots after a slot in which the uplink signal 225 is received, send the acknowledgment indication in a predefined detection window after a slot in which the uplink signal 225 is received, or send the acknowledgment indication in both the slot and the detection window. In some embodiments, the terminal device 110 may listen to the acknowledgment indication in a slot at a predetermined quantity of slots after a slot in which the uplink signal is sent, in a predefined detection window after a slot in which the uplink signal is sent, in both the slot and the detection window.

In some embodiments, the acknowledgment indication may be carried in a medium access control control element (Medium Access Control control element, MAC CE), or carried in downlink control information (downlink control information, DCI), or carried in a radio resource control (RRC) message.

In some embodiments, when a quantity of times of sending the uplink signal 225 is less than the maximum quantity of sending times of sending the uplink signal 225, the terminal device resends the uplink signal 225 to the network device 120 of the second cell when the terminal device 110 does not receive the acknowledgment indication of the uplink signal 225 from the network device 120 of the second cell. It should be noted that the operation of resending the uplink signal 225 may be performed after a preset period of time after the terminal device 110 does not receive the acknowledgment indication of the uplink signal 225 from the network device 120 of the second cell when the quantity of times of sending the uplink signal 225 is less than the maximum quantity of sending times of sending the uplink signal 225.

In some embodiments, after receiving the uplink signal 225, the network device 120 of the second cell may update or store the camped cell of the terminal device 110 as the second cell.

In some embodiments, after receiving the uplink signal 225, the network device 120 of the second cell may send a paging message to the terminal device 110. On the terminal device 110 side, in some embodiments, the terminal device 110 may receive the paging message from the network device 120 of the second cell.

In some embodiments, the second network device 130 may delete information about the terminal device 110 or send information about the terminal device 110 to the first network device 120 based on the notification information 235.

In some embodiments, the terminal device 110 may be in the idle state or the inactive state.

With reference to the foregoing embodiments, the following further describes a communication method in embodiments of this disclosure by using an example in which the network devices 120 and 130 are base stations. It should be noted that other specific examples of the network devices 120 and 130 other than the base stations are also applicable to the following embodiments.

In some embodiments, when a specific trigger condition is satisfied, when the camped cell (a cell on which the terminal device 110 currently camps, or referred to as a current camped cell or a new camped cell) of the terminal device 110 changes, the terminal device 110 is triggered to send an uplink signal carrying a terminal identifier to notify a base station side, for example, notify a base station of the current camped cell. After receiving the message, the base station side updates information about the camped cell of the terminal device 110, so that subsequent paging information for the terminal device 110 may be sent only via the camped cell of the terminal device, helping reduce energy consumption on the base station side. When the base station side does not receive the message (the terminal device 110 does not send the uplink signal), each base station may page the terminal device 110 in a whole RNA area or a whole TA area.

In the solution of this embodiment of this disclosure, when the camped cell of the terminal device 110 changes under the trigger condition, the terminal device 110 is triggered to send the uplink signal 225 carrying the terminal identifier to notify the base station side, so that an increase in energy consumption of the terminal device 110 caused by frequent sending of the uplink signal 225 (which may be referred to as a signal 225 for short) by the terminal device 110 may be avoided.

In some embodiments, the trigger condition of the uplink signal 225 may be predefined based on a protocol or configured by a base station. In some embodiments, there may be one or more trigger conditions. In some embodiments, the base station configured to configure the trigger condition may be a base station (referred to as a base station of an original camped cell) of another cell on which the terminal device 110 camps last time before a current moment. In some embodiments, the base station of the original camped cell is a specific example of the second network device 130, and the base station of the new camped cell is an example of the first network device 120. The original camped cell may be referred to as a first cell, and the new camped cell may be referred to as a second cell.

In some embodiments, the trigger condition of the uplink signal 225 may be: the moving speed of the terminal device 110 is less than the speed threshold. In these embodiments, the terminal device 110 is triggered to send the uplink signal 225 only when the moving speed of the terminal device 110 is less than the speed threshold and the camped cell changes. In this manner, for a fast-moving terminal device 110, a great increase in the energy consumption on the terminal device 110 side caused by frequent sending of the uplink signal 225 by the terminal device 110 due to frequent cell changes can be avoided. In some embodiments, the speed threshold may be predefined by a protocol, or may be notified by a network side (for example, the base station of the original camped cell) to the terminal device 110 via a system message broadcast or an RRC release message.

In some embodiments, the trigger condition of the uplink signal 225 may be: camping time of the terminal device 110 in a cell on which the terminal device previously camps is greater than a time threshold (that is, the first time threshold). In these embodiments, sending of the uplink signal 225 is triggered only when the camping time of the terminal device 110 in the cell on which the terminal device previously camps is greater than the time threshold and the camped cell changes. In this manner, frequent sending of the uplink signal 225 by the terminal device 110 caused by frequent cell changes of the terminal device 110 is avoided, thereby greatly reducing the energy consumption on the terminal device 110 side. In some embodiments, the camping time may be camping time of the terminal device 110 in the cell (for example, the first cell) on which the terminal device camps last time. In some other embodiments, the camping time may be average camping time of the terminal device 110 in cells on which the terminal device camps at different previous moments. In some embodiments, the time threshold may be predefined by a protocol, or may be notified by the network (for example, the base station of the original camped cell) to the terminal device 110 via a system message broadcast or an RRC release message/an RRC release message.

In some embodiments, the trigger condition of the uplink signal 225 may be related to a working status of a base station (for example, the base station of the new camped cell). For example, in some embodiments, the trigger condition of the uplink signal 225 may be that the base station is in a specific working status or some specific working statuses. When the camped cell of the terminal device 110 changes, for the new camped cell of the terminal device 110, the working status of the base station may be obtained by receiving a downlink signal or by using a higher layer signaling indication. To reduce the energy consumption on the base station side, the system may support the base station side in having a plurality of working statuses, and different working statuses have different energy consumption. In some embodiments, the base station may have two working statuses, which respectively correspond to the high energy consumption mode and the low energy consumption mode. In some embodiments, when the terminal device 110 is in a cell in the high energy consumption mode, because working time of the base station is long, sending of a paging message does not bring extra/low energy consumption. Considering that sending of the uplink signal 225 increases the energy consumption on the terminal device 110 side, when the new camped cell of the terminal device 110 is a high energy consumption cell, the terminal device 110 does not send the uplink signal 225. In some other embodiments, the terminal device 110 is in a cell in the low energy consumption mode. In this case, energy consumption of the base station caused by paging sending accounts for a high proportion in total energy consumption overheads. To reduce unnecessary energy consumption overheads on the base station side, when the new camped cell of the terminal device 110 is a low energy consumption cell, the terminal device 110 is triggered to send the uplink signal 225.

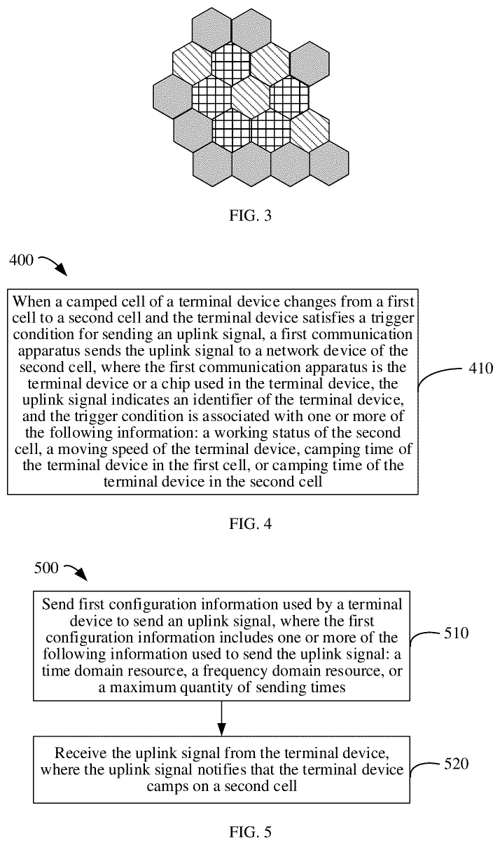

FIG. 3 is a diagram of base stations of different area types according to some embodiments of this disclosure. As shown in FIG. 3, in the figure, a gray area represents a TA area, and a stripe area and a grid area represent an RNA area (the part is optional, and is marked as gray hexagons when the part is optional), where the grid area represents a high energy consumption cell, and the stripe area represents a low energy consumption cell. In the example in FIG. 3, when the base station (for example, the base station of the new camped cell) does not receive the uplink signal 225, the base station pages the terminal device in a plurality of high energy consumption cells in the RNA area in a broadcast manner. When receiving the uplink signal 225, the base station pages the terminal device 110 in a broadcast manner in a cell (for example, the new camped cell) from which the uplink signal 225 is received in the RNA area.

In some embodiments, the trigger condition of the uplink signal 225 may be based on a system message of the camped cell. For example, in some embodiments, when the camped cell of the terminal device 110 changes and a system message of the new camped cell includes a related configuration/indication for sending the uplink signal 225, the terminal device 110 is triggered to send the uplink signal 225.

In some embodiments, the trigger condition of the uplink signal 225 may be based on a cell list. For example, in some embodiments, a first cell list is broadcast in a system message of the original camped cell (that is, the cell on which the terminal device camps last time) of the terminal device 110. When the camped cell of the terminal device 110 changes and the new camped cell belongs to the first cell list, the terminal device 110 is triggered to send the uplink signal 225.

In some embodiments, the first cell list may be obtained based on a message exchanged between base stations, for example, information about low-power cells of the base station exchanged between the base stations.

In some embodiments, the trigger condition of the uplink signal 225 may be based on a terminal device-dedicated paging area configured by a base station (for example, a base station of a cell on which the terminal device 110 previously camps). For example, in some embodiments, when the camped cell of the terminal device 110 changes, whether the terminal device 110 sends the uplink signal 225 depends on whether the new camped cell of the terminal device 110 is in the terminal device-dedicated paging area (for example, a UE-dedicated paging area). The terminal device-dedicated paging area may be notified by a network to the terminal device 110 via an RRC release message. In some embodiments, the RRC release message may include a list of cells in which the terminal device 110 can directly receive paging (that is, the terminal device does not need to send the uplink signal 225). When the new camped cell of the terminal device 110 is not in the list, the terminal device 110 is triggered to send the uplink signal 225.

In some embodiments, the terminal device-dedicated paging area may be related to a working status of the base station, for example, obtained by the base station by using the working status of the base station exchanged between base stations. Base stations that perform exchange may include the base station of the original camped cell, the base station of the new camped cell, and the like.

In some embodiments, the trigger condition of the uplink signal 225 may be a combination of the trigger condition listed in some or all of the foregoing embodiments, that is, may be that only one or more items in the foregoing condition are satisfied.

In some embodiments, the uplink signal 225 may include the identifier of the terminal device 110, and the identifier of the terminal device 110 may be used by the base station side to identify a user. For example, the base station of the new camped cell may identify the terminal device 110 by using the identifier.

In some embodiments, the uplink signal 225 may include a preamble sequence and data, where the data may include (or include only) the identifier of the terminal device 110. In these embodiments, the preamble sequence and the data are adjacent in time domain and have a same bandwidth or respectively use different bandwidths based on a manner predefined in a protocol in frequency domain, or the preamble sequence and the data are adjacent in frequency domain and respectively use different bandwidths based on a manner predefined in a protocol in frequency domain. In some embodiments, the identifier of the terminal device 110 may be based on a sequence. In some other embodiments, the identifier of the terminal device 110 may be based on a message. In this message-based case, a modulation scheme, a channel coding scheme, a waveform, a multi-antenna, or the like used for sending the message may be obtained through predefinition that is based on a protocol or through configuration that is performed by the base station (for example, the base station of the cell on which the terminal device previously camps, for example, the base station of the original camped cell).

In some embodiments, to support sending of the uplink signal 225, a system message of the base station (for example, the base station of the new camped cell) may include a sending occasion of the uplink signal 225 (that is, a time domain position at which the uplink signal may be sent), a time-frequency resource, a reference signal configuration, and a table, a waveform, or channel coding of an MCS (modulation and coding scheme, modulation and coding scheme) of a PUSCH (physical uplink shared channel, physical uplink shared channel) when the identifier of the terminal device 110 is sent in a message manner. In some embodiments, the time domain position may be directly indicated. In some other embodiments, the foregoing time domain position is jointly indicated by using a periodicity and an offset.

In some embodiments, in addition to the identifier of the terminal device 110, the uplink signal 225 may further include the location information of the terminal device 110, so that when subsequently paging the terminal device 110, the base station may send a paging message by using a narrower beam. In some embodiments, the location information of the terminal device 110 may be a zone ID, GPS (global positioning system, global positioning system) information, or the like. It can be learned from these embodiments that the uplink signal 225 in embodiments of this disclosure further indicates one or more information such as the location information of the terminal device 110 or the beam information that the terminal device 110 expects to receive a paging message.

In some embodiments, the uplink signal 225 may be Msg A in 2-step RACH (two-step random access). That is, the uplink signal 225 may be sent by multiplexing a 2-step RACH procedure. In some embodiments, an independent preamble (preamble) resource may be configured based on a configuration in the 2-step RACH, and is used by the base station side to identify that a purpose of the uplink signal 225 is not to initiate random access but to notify that the camped cell of the terminal device 110 changes. An example in which the terminal device 110 is UE is used, the two-step random access includes two parts: MSGA sending and MSGB receiving. MSGA sending can be further divided into RA preamble sending and PUSCH payload sending, which correspond to MSG1 and MSG3 in four-step random access. The UE receives determination of contention resolution through MSGB. Content of the MSGB is relatively complex, and is mainly divided into three cases: 1. Success RAR (random access response, random access response): This means that the contention resolution succeeds, the success RAR carries a MAC PDU, that is, original content of MSG4 in the four-step random access, and the random access succeeds. 2. Fallback RAR: This means rolling back to the MSG3 of the four-step random access, a structure of the fallback RAR is similar to that of an RAR of MSG2 in the four-step random access, and means that the base station matches access on a PRACH (Physical Random Access Channel, physical random access channel) but does not match access on the PUSCH. Therefore, a grant needs to be delivered in the fallback RAR, to enable the UE to resend the PUSCH in the form of the MSG3 and then perform contention resolution by using the MSG4. 3. Absolute TA MAC CE: If CFRA (contention-free random access, contention-free random access) is triggered by a handover, an absolute TA value (Timing Advance, timing advance) needs to be delivered through the MSGB to keep uplink synchronization between the UE and the base station.

In some embodiments, the identifier of the terminal device 110 may reuse a UE identifier (an example of the identifier of the terminal device 110) in an RRCSetupRequest or an RRCResumeRequest. The RRCSetupRequest is used by the terminal device 110 in an RRC idle state (idle state) to establish an RRC connection, and a 30-bit ng-5G-S-TMSI-Part1 (a higher layer configures a 5G-S-TMSI) or a 39-bit random value (a higher layer does not configure a 5G-S-TMSI) is used as an identity of the terminal device 110, where the 5G-S-TMSI includes an AMF (access and mobility management function, access and mobility management function) Set ID, an AMF pointer, and a 5G-TMSI. The RRCResumeRequest is used by the terminal device 110 in an RRC inactive state (inactive state) to restore a connection, where an RRCResumeRequest1 uses a 40-bit full I-RNTI, and the RRCResumeRequest uses a 24-bit short I-RNTI. A value of the I-RNTI is indicated by using suspendConfig. It should be noted that, in a 6G system, a TMSI (temporary mobile subscriber identity, temporary mobile subscriber identity) configured by a core network may have another name. Herein, only an identifier defined in 5G is used as an example.

In some embodiments, the uplink signal 225 is sent by defining new uplink signaling. In this manner, the RRCSetupRequest message or the RRCResumeRequest message is not reused, but a new uplink RRC message is defined, and the new uplink RRC message is used to carry only identification information of the terminal device 110, where the identification information may be a TMSI configured by a core network or a UE identifier configured in an LP-WUS (the LP-WUS is a low-power wake-up signal, and when the terminal device 110 side receives the LP-WUS signal that includes the identifier of the terminal device 110, the terminal device 110 wakes up a main receiver module of the terminal device, and establishes a connection with the base station. An LP-WUR is a Low-Power Wake-Up Receiver, and is a low-power receiver on the terminal device 110 side).

It should be noted that, different from a case of replying with msg B or triggering 4-step RACH fallback after receiving the msg A in the 2-step RACH, in embodiments of this disclosure, after receiving the uplink signal 225, the base station only needs to reply with a MAC CE to acknowledge reception, and related information of the MAC CE is further described below.

In some embodiments, the uplink signal 225 may a terminal identifier based on a sequence. In this manner, different sequences carry different terminal identifiers. For example, scrambling may be performed by using different terminal identifiers. The sequence is another sequence (an example of the predefined sequence in the foregoing embodiment) different from the preamble sequence.

In some embodiments, after determining, based on the trigger condition of the uplink signal 225, that the terminal device 110 needs to send the uplink signal 225, the terminal device 110 may determine the transmit power of the uplink signal 225, to avoid unnecessary power waste. When the transmit power of the uplink signal 225 is determined, different implementations may be used based on different scenarios, which are separately described below.

In some embodiments, the terminal device 110 may determine the transmit power of the uplink signal 225 based on receive power of a downlink synchronization signal/discovery signal of the base station (for example, the base station of the new camped cell of the terminal device 110). In some embodiments, the base station may indicate transmit power of the downlink synchronization signal/discovery signal via a system message or the like. The terminal device 110 may determine a path loss value between the base station and the terminal device 110 based on the receive power of the downlink synchronization signal/discovery signal and the transmit power broadcast by the base station, to further determine the transmit power of the uplink signal 225.

In some embodiments, the terminal device 110 may determine the transmit power of the uplink signal 225 based on receive power of an LP-SS signal (Low-Power Synchronization Signal, low-power synchronization signal). In some embodiments, a signal sent by the base station (for example, the base station of the new camped cell of the terminal device 110) is a low-power synchronization signal LP-SS. Because coverage of the low-power synchronization signal is limited, the base station ensures coverage in a repeated sending manner. In addition, the base station indicates transmit power of the LP-SS and a quantity of times of repeated sending in time domain, and the terminal device determines the transmit power of the uplink signal 225 based on received signal strength and the transmit power of the low-power synchronization signal, and a quantity of repetition times of the LP-SS (it should be noted that in this case, this may also be a quantity of repetition times of the LP-SS received by the terminal device 110, which may be less than a total quantity of times of sending by the base station).

In some embodiments, the terminal device 110 may determine the transmit power of the uplink signal 225 based on an acknowledgment reply for the uplink signal 225. In some embodiments, after receiving the uplink signal 225, the base station (for example, the base station of the new camped cell of the terminal device 110) replies to the terminal device 110 with a corresponding acknowledgment message (an example of the acknowledgment indication of the uplink signal 225). Considering impact of a delay, overheads, and the like, the acknowledgment message may be carried by using a MAC CE, that is, a dedicated MAC CE is defined to carry the acknowledgment reply message.

In some embodiments, for content of the MAC CE, specifically, the MAC CE may not carry any information, to avoid a conflict problem of the terminal device 110 (for example, UE). In some embodiments, the MAC CE may alternatively carry some or all UE identifiers in the uplink signal 225, or another value predefined in a protocol. In some embodiments, for scrambling of the MAC CE, a dedicated RNTI (Radio Network Temporary Identity, radio network temporary identity) may be defined for scrambling of the MAC CE.

For a timing relationship between the MAC CE and the uplink signal 225, in some embodiments, a fixed time sequence manner may be used: the uplink signal 225 is sent in a slot n, and the MAC CE is received in a slot n+k, where k is predefined in a protocol or based on a configuration. In some other embodiments, a detection window-based manner may be used: the uplink signal 225 is sent in a slot n, and the MAC CE is received starting from a slot n+k by using a window length predefined in a protocol.

In some embodiments, when the terminal device 110 does not receive or detect the MAC CE, the terminal device 110 may determine, based on an indication of the base station, whether to trigger retransmission. Specifically, the base station may broadcast retransmission indication information and a quantity of retransmission times (notified in a broadcast form) in a configuration message of the uplink signal 225. If the base station indicates that retransmission is supported, the terminal device 110 sends the uplink signal 225 on a next uplink signal sending occasion. In some embodiments, the quantity of retransmission times may alternatively be predefined in a protocol. For example, a maximum quantity of retransmission times is 5. In some other embodiments, the base station of the new camped cell of the terminal device 110 may configure the maximum quantity of sending times of the uplink signal 225. When the quantity of times of sending the uplink signal 225 is less than the maximum quantity of sending times, when the terminal device 110 does not receive the acknowledgment indication of the uplink signal 225 from the base station of the new camped cell, the terminal device may resend the uplink signal 225 to the base station of the new camped cell.

In some embodiments, after receiving the uplink signal 225 sent by the terminal device 110, the new camped cell of the terminal device 110 may interact with the original camped cell, to notify the original camped cell to delete information about the terminal device 110, or notify the original camped cell to send information about the terminal device 110 to the new camped cell, so as to prevent the original camped cell from subsequently paging the UE, thereby avoiding unnecessary paging sending in the original camped cell.

With reference to the foregoing embodiments, the following describes a schematic flowchart implemented at a first communication apparatus according to some embodiments of this disclosure. The first communication apparatus may be the terminal device 110 mentioned above or a chip used in the terminal device 110. As shown in FIG. 4, in a procedure 400 implemented at the first communication apparatus, in a block 410, when a camped cell of the terminal device 110 changes from a first cell to a second cell and the terminal device 110 satisfies a trigger condition for sending an uplink signal 225, the first communication apparatus sends the uplink signal 225 to a network device 120 of the second cell, where the uplink signal 225 indicates an identifier of the terminal device 110, and the trigger condition is associated with one or more of the following information: a working status of the second cell, a moving speed of the terminal device, camping time of the terminal device in the first cell, or camping time of the terminal device in the second cell.

With reference to the foregoing embodiments, the following describes a schematic flowchart implemented at a second communication apparatus according to some embodiments of this disclosure. The second communication apparatus may be the network device 120 (namely, the first network device 120) of the second cell mentioned above, or may be a chip used in the network device 120 of the second cell. As shown in FIG. 5, in a procedure 500 implemented at the second communication apparatus, in a block 510, the second communication apparatus may send first configuration information 205 used by a terminal device 110 to send an uplink signal 225. The first configuration information 205 includes one or more of the following information used to send the uplink signal 225: a time domain resource, a frequency domain resource, or a maximum quantity of sending times. In a block 520, the second communication apparatus may receive the uplink signal 225 from the terminal device 110, where the uplink signal 225 notifies that the terminal device 110 camps on the second cell.

With reference to the foregoing embodiments, the following describes a schematic flowchart implemented at a third communication apparatus according to some embodiments of this disclosure. The third communication apparatus may be the second network device 130 of the first cell, or may be a chip used in the second network device 130. As shown in FIG. 6, in a procedure 600 implemented at the third communication apparatus according to some embodiments of this disclosure, in a block 610, the third communication apparatus may send, to a terminal device 110, second configuration information 215 used by the terminal device 110 to obtain a trigger condition for sending an uplink signal. The trigger condition is associated with one or more of a working status of a second cell, a moving speed of the terminal device 110, camping time of the terminal device 110 in the first cell, or camping time of the terminal device 110 in the second cell. The uplink signal 225 indicates an identifier of the terminal device 110. In a block 620, the third communication apparatus may receive notification information from a first network device 120, where the notification information indicates that a camped cell of the terminal device 110 changes from the first cell to the second cell.

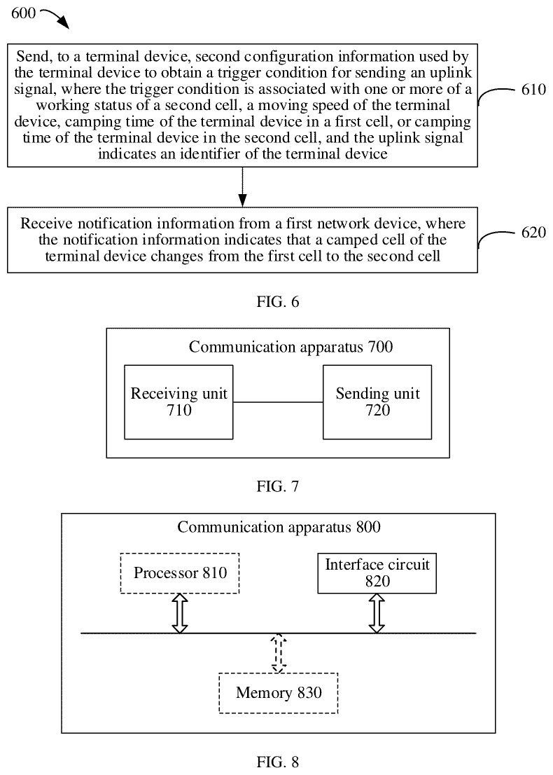

FIG. 7 is a diagram of main composition of a possible communication apparatus according to an embodiment of this disclosure. The communication apparatus may implement functions of the first communication apparatus, the second communication apparatus, or the third communication apparatus in the foregoing method embodiments, and therefore can also achieve the beneficial effects of the foregoing method embodiments. In this embodiment of this disclosure, for the network device 120 shown in FIG. 1A that is used as an example of the second communication apparatus, the communication apparatus may alternatively be a module (for example, a chip) used in the network device 120.

An example in which the communication apparatus implements the functions of the second communication apparatus is used. As shown in FIG. 7, the communication apparatus 700 includes a receiving unit 710 and a sending unit 720. The communication apparatus 700 may be configured to implement the functions of the second communication apparatus in the method embodiment shown in FIG. 5 or the network device 120 shown in FIG. 1A. In some embodiments, the sending unit 720 may be a transmitter, and the receiving unit 710 may be a receiver.

When the communication apparatus 700 is configured to implement the functions of the network device 120 in the method embodiment shown in FIG. 1A, the sending unit 720 is configured to send first configuration information 205 used by a terminal device 110 to send an uplink signal 225. The first configuration information 205 includes at least one of the following information used to send the uplink signal 225: a time domain resource, a frequency domain resource, or a maximum quantity of sending times. The receiving unit 710 is configured to receive the uplink signal 225 from the terminal device 110, where the uplink signal 225 notifies that the terminal device 110 camps on a second cell.

A case in which the communication apparatus implements the functions of the first communication apparatus or the third communication apparatus is similar to the foregoing descriptions, and is not described. In addition, for more detailed descriptions of the receiving unit 710 and the sending unit 720, refer to related descriptions in the foregoing method embodiments. Details are not described herein again.

As shown in FIG. 8, a communication apparatus 800 includes an interface circuit 820. Optionally, the communication apparatus may further include a processor 810. The processor 810 and the interface circuit 820 are coupled to each other. It may be understood that the interface circuit 820 may be a transceiver or an input/output interface. Optionally, the communication apparatus 800 may further include a memory 830, configured to: store instructions executed by the processor 810, or store input data needed by the processor 810 to run the instructions, or store data generated after the processor 810 runs the instructions.

When the communication apparatus 800 is configured to implement the method in the method embodiment in FIG. 4, FIG. 5, or FIG. 6, the interface circuit 820 is configured to perform a function of the sending unit or the receiving unit. For example, when the communication apparatus is configured to implement the method in the embodiment shown in FIG. 5, the interface circuit 820 may be configured to perform the functions of the sending unit 720 and the receiving unit 710.

When the communication apparatus is a chip used in the terminal device 110 or a network device (for example, the first network device 120 or the second network device 130), the chip in the terminal device implements corresponding functions of the terminal device 110, the first network device 120, or the second network device 130 in the foregoing method embodiments. The terminal device 110 is used as an example. The chip in the terminal device receives information from another module (for example, a radio frequency module or an antenna) in the terminal device 110, and the information may be sent by the network device (for example, the first network device 120 or the second network device 130); or the chip in the terminal device sends information to another module (for example, a radio frequency module or an antenna) in the terminal device 110, and the information is sent to the network device (for example, the first network device 120 or the second network device 130).

It may be understood that, the processor in embodiments of this application may be a central processing unit (central processing unit, CPU), or may be another general-purpose processor, a digital signal processor (digital signal processor, DSP), an application-specific integrated circuit (application-specific integrated circuit, ASIC), a field programmable gate array (field programmable gate array, FPGA) or another programmable logic device, a transistor logic device, a hardware component, or any combination thereof. The general-purpose processor may be a microprocessor or any regular processor.

An embodiment of this application provides a communication system. The communication system may include the communication apparatus in the embodiment shown in FIG. 7, such as the terminal device 110, the network devices 120 and 130, and the like. Optionally, the terminal device 110 or 120 in the communication system may perform the communication method shown in FIG. 4. In some other embodiments, the communication system may include a communication apparatus that may perform the communication method shown in FIG. 5, for example, the network device 120. In some other embodiments, the communication system may include a communication apparatus that may perform the communication method shown in FIG. 6, for example, the network device 130.

An embodiment of this application further provides a circuit. The circuit may be coupled to a memory, and may be configured to perform a procedure related to the terminal device 110, the network device 120, or the network device 130 in any one of the foregoing method embodiments. A chip system may include a chip, and may further include another component, for example, a memory or a transceiver.

It should be understood that the processor mentioned in embodiments of this application may be a CPU, or may be another general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate or a transistor logic device, a discrete hardware component, or the like. The general-purpose processor may be a microprocessor, or the processor may be any regular processor or the like.

It should be further understood that the memory mentioned in embodiments of this application may be a volatile memory or a nonvolatile memory, or may include both a volatile memory and a nonvolatile memory. The nonvolatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), used as an external cache. Through example but not limitative description, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM), and a direct rambus random access memory (direct rambus RAM, DR RAM).

It should be noted that when the processor is a general-purpose processor, a DSP, an ASIC, an FPGA or another programmable logic device, a discrete gate or a transistor logic device, or a discrete hardware component, the memory (a storage module) is integrated into the processor.

It should be noted that the memory described in this specification aims to include but is not limited to these memories and any memory of another proper type.

It should be understood that sequence numbers of the foregoing processes do not mean execution sequences in various embodiments of this application. The execution sequences of the processes should be determined according to functions and internal logic of the processes, and should not be construed as any limitation on the implementation processes of embodiments of this application.

A person of ordinary skill in the art may be aware that, in combination with the examples described in embodiments disclosed in this specification, modules and algorithm steps can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and module, refer to a corresponding process in the foregoing method embodiments, and details are not described herein again.

In the several embodiments provided in this application, it should be understood that the disclosed communication method and apparatus may be implemented in other manners. For example, the described apparatus embodiments are merely examples. For example, division into the modules is merely logical function division and there may be other division in an actual implementation. For example, a plurality of modules or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or other forms.

The modules described as separate components may or may not be physically separate, and components displayed as modules may or may not be physical modules, that is, may be located in one position or may be distributed on a plurality of network units. Some or all of the units may be selected based on actual requirements to achieve the objectives of the solutions of embodiments.

In addition, functional modules in embodiments of this application may be integrated into one processing module, or each of the modules may exist alone physically, or two or more modules are integrated into one module.

When the functions are implemented in the form of a software functional module and sold or used as an independent product, the functions may be stored in a computer-readable storage medium. Based on such an understanding, the technical solutions of this application essentially, or a part contributing to the technical solutions, or some of the technical solutions may be implemented in a form of a software product. The computer software product is stored in a storage medium and includes several instructions for instructing a computer device (which may be a personal computer, a server, a network device, or the like) to perform all or some of the steps of the methods in embodiments of this application. The computer-readable storage medium may be any usable medium that can be accessed by a computer. This is used as an example but is not limited to: The computer-readable medium may include a random access memory (random access memory, RAM), a read-only memory (read-only memory, ROM), an electrically erasable programmable read-only memory (electrically erasable programmable read-only memory, EEPROM), a compact disc read-only memory (compact disc read-only memory, CD-ROM), a universal serial bus flash disk (universal serial bus flash disk), a removable hard disk, or another optical disc storage, a magnetic disk storage medium or another magnetic storage device, or any other medium that can be used to carry or store expected program code in a form of an instruction or a data structure and that can be accessed by a computer.

As used in this specification, the term “including” and similar terms should be understood as open inclusion, that is, “including but not limited to”. The term “based on” should be understood as “at least partially based on”. The term “one embodiment” or “this embodiment” should be understood as “at least one embodiment”. The terms such as “first”, “second”, and the like may refer to different objects or a same object, and are merely used to distinguish between indicated objects, but do not imply a specific spatial order, a time order, an importance order, or the like of the indicated objects. In some embodiments, a value, a process, a selected item, a determined item, a device, an apparatus, a means, a part, a component, or the like is referred to as “optimal”, “lowest”, “highest”, “minimum”, “maximum”, or the like. It should be understood that such a description is intended to indicate that a selection may be performed among many available functional selections, and that such a selection does not need to be better, lower, higher, smaller, larger, or otherwise preferred than other selections in other aspects or in all aspects. As used in this specification, the term “determining” may cover a variety of actions. For example, “determining” may include operating, calculating, processing, exporting, investigating, looking up (for example, looking up in a table, a database, or another data structure), finding, and the like. In addition, “determining” may include receiving (for example, receiving information), accessing (for example, accessing data in a memory), and the like. In addition, “determining” may include parsing, selecting, choosing, establishing, and the like.

The foregoing descriptions are merely specific implementations of this application, but are not intended to limit the protection scope of embodiments of this application. Any variation or replacement readily figured out by a person skilled in the art within the technical scope disclosed in embodiments of this application shall fall within the protection scope of embodiments of this application. Therefore, the protection scope of embodiments of this application should be subject to the protection scope of the claims.

1. A communication method, comprising:
when a camped cell of a terminal device changes from a first cell to a second cell and the terminal device satisfies a trigger condition for sending an uplink signal, sending, by the terminal device, the uplink signal to a network device of the second cell, wherein the uplink signal indicates an identifier of the terminal device, and the trigger condition is associated with at least one of the following: a working status of the second cell, a moving speed of the terminal device, camping time of the terminal device in the first cell, or camping time of the terminal device in the second cell.

2. The method according to claim 1, wherein the uplink signal notifies that the terminal device camps on the second cell.

3. The method according to claim 1, wherein the uplink signal further indicates at least one of location information of the terminal device or beam information that the terminal device expects to receive a paging message.

4. The method according to claim 1, wherein the trigger condition is associated with the working status of the second cell; and
sending, by the terminal device, the uplink signal to the network device comprises:
sending, by the terminal device, the uplink signal to the network device when the working status of the second cell is a low energy consumption state.

5. The method according to claim 1, further comprising:
receiving first configuration information from the network device, wherein the first configuration information comprises at least one of the following information used to send the uplink signal:
a time domain resource;
a frequency domain resource; or
a maximum quantity of sending times.

6. The method according to claim 1, wherein the trigger condition comprises at least one of the following:
the moving speed of the terminal device is less than a speed threshold;
the camping time of the terminal device in the first cell is greater than a first time threshold;
the camping time of the terminal device in the second cell is greater than a second time threshold;
a paging cell list in a system message of the first cell comprises the second cell; or
a dedicated paging area of the terminal device does not comprise the second cell.

7. The method according to claim 1, wherein the trigger condition is predefined, or is obtained from second configuration information of a network device of the first cell.

8. The method according to claim 1, wherein the second time threshold is obtained from the network device of the second cell.

9. The method according to claim 1, wherein the uplink signal indicates the identifier of the terminal device by using at least one of the following:
a radio resource control RRC message;
a wake-up signal;
an associated preamble sequence; or
a predefined sequence.

10. The method according to claim 1, further comprising:
determining, by the terminal device, transmit power of the uplink signal based on received signal strength and transmit power of a low-power synchronization signal sent by the network device of the second cell, and a quantity of repetition times of the low-power synchronization signal, wherein the quantity of repetition times of the low-power synchronization signal is a quantity of times that the network device of the second cell repeatedly sends the low-power synchronization signal or a quantity of times that the terminal device repeatedly receives the low-power synchronization signal.

11. The method according to claim 1, further comprising:
receiving, by the terminal device, an acknowledgment indication of the uplink signal from the network device of the second cell.

12. The method according to claim 11, wherein the acknowledgment indication is listened to in at least one of the following:
a slot at a predetermined quantity of slots after a slot in which the uplink signal is sent; or
a predefined detection window after a slot in which the uplink signal is sent.

13. An apparatus, comprising:
at least processor; and
a non-transitory computer-readable medium including computer-executable instructions that, when executed by the processor, cause the apparatus to carry out a method including:
when a camped cell of a terminal device changes from a first cell to a second cell and the terminal device satisfies a trigger condition for sending an uplink signal, sending, by the terminal device, the uplink signal to a network device of the second cell, wherein the uplink signal indicates an identifier of the terminal device, and the trigger condition is associated with at least one of the following: a working status of the second cell, a moving speed of the terminal device, camping time of the terminal device in the first cell, or camping time of the terminal device in the second cell.

14. The apparatus according to claim 13, wherein the uplink signal notifies that the terminal device camps on the second cell.

15. The apparatus according to claim 13, wherein the uplink signal further indicates at least one of location information of the terminal device or beam information that the terminal device expects to receive a paging message.

16. The apparatus according to claim 13, wherein the trigger condition is associated with the working status of the second cell; and
sending, by the terminal device, the uplink signal to the network device comprises:
sending, by the terminal device, the uplink signal to the network device when the working status of the second cell is a low energy consumption state.

17. The apparatus according to claim 13, the method further comprising:
receiving first configuration information from the network device, wherein the first configuration information comprises at least one of the following information used to send the uplink signal:
a time domain resource;
a frequency domain resource; or
a maximum quantity of sending times.

18. The apparatus according to claim 13, wherein the trigger condition comprises at least one of the following:
the moving speed of the terminal device is less than a speed threshold;
the camping time of the terminal device in the first cell is greater than a first time threshold;
the camping time of the terminal device in the second cell is greater than a second time threshold;
a paging cell list in a system message of the first cell comprises the second cell; or
a dedicated paging area of the terminal device does not comprise the second cell.

19. The apparatus according to claim 13, wherein the trigger condition is predefined, or is obtained from second configuration information of a network device of the first cell.

20. The apparatus according to claim 13, wherein the second time threshold is obtained from the network device of the second cell.
